(19) United States
(12) Patent Application Publication
(10) Pub. No.: US 2003/0084455 A1
(43) Pub. Date: May 1, 2003

(54) System and method for alternate content delivery

(76) Inventors: Greg Gudorf, San Diego, CA (US); Aaron Dew, San Diego, CA (US); Anthony Lionel Creed, San Diego, CA (US); Matthew Chang, San Diego, CA (US); William Hausch, Culver City, CA (US)

Correspondence Address: John L. Rogitz, Rogitz & Associates, Suite 3120, 750 B Street, San Diego, CA, 92101, US

(21) Appl. No.: 10/000,850

(22) Filed: Oct. 29, 2001

(51) Int. Cl. G06F 3/00; H04N 5/445; G06F 13/00; H04N 7/173

(52) U.S. Cl. 725/109; 725/110; 725/51; 348/563

(57) ABSTRACT

A system and method for presenting out of band content on a TV includes an out of TV band receiver such as a radio that receives content peer to peer from other TVs, or from a server. The content is cached at the receiving TV and is played on the TV automatically in response to a predetermined rule being satisfied, or on demand from the viewer, giving the appearance of a real time connection.

### BACKGROUND OF THE INVENTION

1. Field of the Invention

The present invention relates generally to television systems.

2. Description of the Related Art

Televisions and computers have become ubiquitous, and since both usually entail a visual display, efforts have been made to integrate both functions into a single system. In this way, a consumer need not purchase and operate two separate systems, which can burden some consumers who, while familiar with operating a television and its remote control, might not be familiar with operating, e.g., an Internet computer.

To the extent that attempts have been made to combine television with Internet features, it has generally been with the focus of producing what might be thought of as a “lean forward” system. That is, hybrid TV/computers have typically been more oriented toward productivity, generally thought of as a computer system characteristic, and less toward entertainment (“lean back”), generally regarded as a television system characteristic. It is not just the dichotomy between productivity and entertainment that distinguishes a “lean forward” experience from a “lean back” experience, however. As contemplated herein, “lean forward” activities often are experienced by only a single person, while “lean back” activities are often group experiences. Moreover, “lean back” activities can extend to purchasing products that are advertised on TV, as opposed to, e.g., making products for sale. In any case, with the above-mentioned critical observation of the present invention in mind, it can readily be appreciated that the differences between a system designed for “lean forward” experiences and a system designed for “lean back” experiences can be both subtle and profound.

An example of a “lean forward” system is the system known as “WebTV”, with preselected Web pages being accessible through the television using a computer keyboard with its attendant complexity. To access the pages, the consumer must access a central site by means of the keyboard, and then be redirected to a desired Web page. In terms of currently expected speeds of Internet access, this consumes an undue amount of time. Furthermore, it requires browser or browser-like operations that must be executed by a consumer. All of these features—use of a keyboard, knowledgeable use of a browser, and wait time for Web page access—are not per se unacceptable for a lean forward experience, but would severely detract from a lean back experience.

For instance, in the context of lean back, entertainment- and group-oriented experiences, consumers are accustomed to using a much simpler input device than a computer keyboard, namely, a remote control. Moreover, a user interface that is simpler than a Web browser, e.g., an electronic program guide (EPG), is preferred. Also, waiting for entertainment to load or otherwise be prepared for playing is distracting in a lean-back, group-oriented experience. But as exemplified above by the WebTV system, current systems that attempt to integrate television and computers essentially do so by grafting a TV onto what is essentially an underlying, lean forward computer system, and consequently provide less than optimum lean back experiences. As an example, in a group lean back experience, viewers might wish to obtain interesting information via a TV in addition to conventional TV broadcasts. The object of the present invention is to provide a TV system that accommodates lean back experiences better than existing systems.

### SUMMARY OF THE INVENTION

The invention provides a way to provide broadcast content to a TV viewer without passing the content through conventional TV gateways such as broadcasters, cable, or satellite.

Accordingly, a system for presenting content on a TV includes a receiver TV presenting broadcast TV content, and a receiver such as an AM radio receiver or pager receiver as examples. A data cache receives cache content via the receiver, and a processor communicates with the data cache and presents the cache content on the TV.

In a preferred implementation, the processor presents the cache content in response to a viewer-generated signal. In another implementation, the processor automatically presents the cache content in accordance with at least one cache content presentation rule. A sender TV can send the cache content to the receiver TV peer-to-peer, or the content can originate at a server in a server-to-client architecture.

In another aspect, a system for presenting content on a TV includes a receiver TV presenting broadcast TV content. The system further includes a cache content receiver and a data cache that receives cache content via the receiver. A processor communicates with the data cache and presents the cache content on the TV.

In still another aspect, a method for presenting TV content and cache content on a TV simultaneously with each other is disclosed. The method includes receiving a TV signal and presenting it on a TV, and also receiving cache content and storing the cache content in a data cache. In response to a cache content presentation rule or a viewer-generated signal, cache content from the data cache is presented on the TV along with the TV content.

In yet another aspect, a system for presenting out of band content on a TV includes receiver TV means for displaying television signals. Out of band content receiver means are associated with the receiver TV means for presenting out of band content on the TV. The out of band content is not a television signal although the TV signal may be co-opted to deliver the content.

### BRIEF DESCRIPTION OF THE DRAWINGS

The details of the present invention, both as to its structure and operation, can best be understood in reference to the accompanying drawings, in which like reference numerals refer to like parts, and in which:

FIG. 1 is a block diagram of the system of the present invention; and

FIG. 2 is a flow chart of the present logic.

### DETAILED DESCRIPTION OF THE PREFERRED EMBODIMENTS

This invention provides a way for TV viewers to avail themselves of out of TV band content without the content passing through conventional TV gateways such as broadcast, cable, or satellite.

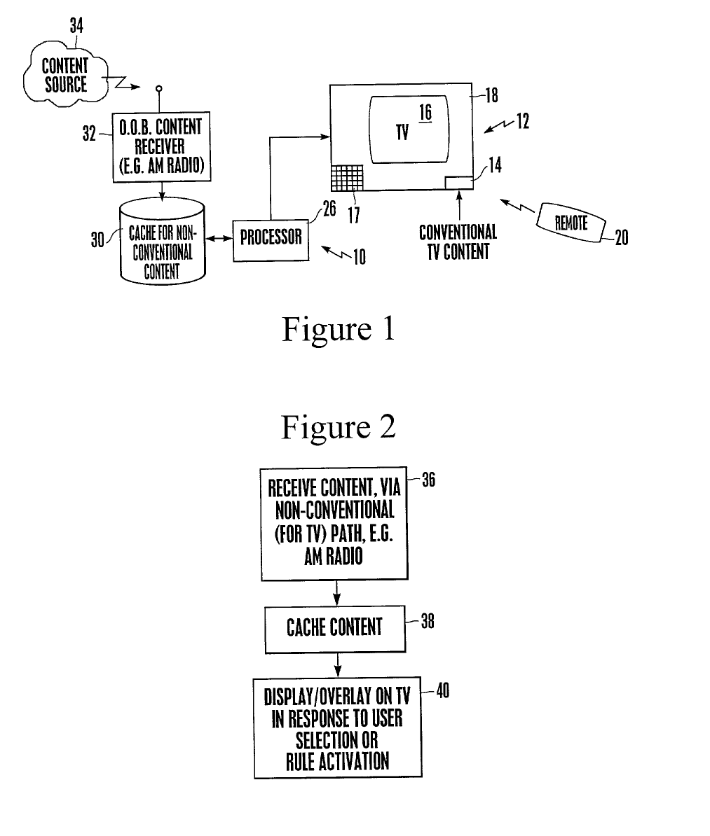

Referring initially to FIG. 1, a system is shown, generally designated 10. As shown, the system 10 includes a TV 12 that conventionally receives televised content at a content receiver 14 (e.g., an antenna, cable receiver, satellite dish, set-top box, etc.) for display of the content on a monitor 16 and associated speakers 17.

While the embodiment below discusses a TV 12 with a single housing that is shown separate from the microprocessor and database, it is to be understood that the term “television” encompasses any apparatus that has a television tuner and the below-described capability in a single housing or in separate housings that cooperate together. For instance, the term “TV” encompasses the television system shown in FIG. 1, as well as a conventional television in combination with a set-top box that functions in accordance with the present invention. In the latter example, the set-top box might include, e.g., the microprocessor discussed below.

In the preferred non-limiting embodiment shown, the TV 12 includes a housing 18 that holds a conventional television tuner which receives the TV signals. A remote control device 20 can also be provided. Moreover, a microprocessor 26 communicates with the TV circuitry for presenting out of band data on the monitor 16/speakers 17 in accordance with the disclosure below. As intimated above, the microprocessor 26 can be located in the housing 18 or it can be disposed elsewhere, such as in a set-top box or in the remote control device 20 or other component. In any case, the microprocessor 26 executes the logic set forth herein. The microprocessor 26 can also access a database 30 of content cache, with the database 30 being contained in computer memory, or on a hard disk drive, optical drive, solid state storage, tape drive, removable flash memory, or any other suitable data storage medium and potentially accessible to a network such as the Internet.

It is to be understood that the microprocessor 26 controls certain functions of the TV 12 in accordance with the logic below. The flow charts herein illustrate the structure of the logic modules of the present invention as embodied in computer program software. Those skilled in the art will appreciate that the flow charts illustrate the structures of logic elements, such as computer program code elements or electronic logic circuits, that function according to this invention. Manifestly, the invention is practiced in its essential embodiment by a machine component that renders the logic elements in a form that instructs a digital processing apparatus (that is, a computer or microprocessor) to perform a sequence of function steps corresponding to those shown. Internal logic could be as simple as a state machine.

In other words, the present logic may be established as a computer program that is executed by a processor within, e.g., the present microprocessors/servers as a series of computer-executable instructions. In addition to residing on hard disk drives, these instructions may reside, for example, in RAM of the appropriate computer, or the instructions may be stored on magnetic tape, electronic read-only memory, or other appropriate data storage device.

As also shown in FIG. 1, the content cache database 30 receives non-conventional content (relative to conventional TV content) via an out of band content receiver 32. In one preferred, non-limiting embodiment, the out of band content receiver is a broadcast receiver such as an AM radio receiver or pager receiver, as opposed to a POTS line/Internet content receiver. For instance, the out of band content receiver 32 can be a Radio Data Service (RDS) receiver. In any case, the out of band content receiver 32 can be mounted on or incorporated into the TV 12 or associated system 10 component such as but not limited to a set top box, VCR, TiVO-type device, etc.

FIG. 1 shows that the content receiver 32 receives out of band content from a source 34. The source 34 can be another TV, in which case the out of band content is sent peer-to-peer. Alternatively, the source 34 can be server associated with a radio station transmitter.

The logic of the present invention can be seen in reference to FIG. 2. Commencing at block 36, the out of band content is received by the receiver 32 via a non-conventional (for TV) broadcast path, and then it is cached at block 38 in the cache content database 30. At block 40, the content is displayed by superimposing it on the TV channel being displayed at the same time. The display of the cache content can be in response to a viewer command entered by means of, e.g., the remote control device 20, or it can be presented in accordance with one or more display rules. For example, it might be desired that whenever a viewer activates a pay per view purchase from their cable or satellite system, cache content is presented that includes an independent presentation, e.g., a leader of a movie that has been selected.

While the particular SYSTEM AND METHOD FOR ALTERNATE CONTENT DELIVERY as herein shown and described in detail is fully capable of attaining the above-described objects of the invention, it is to be understood that it is the presently preferred embodiment of the present invention and is thus representative of the subject matter which is broadly contemplated by the present invention, that the scope of the present invention fully encompasses other embodiments which may become obvious to those skilled in the art, and that the scope of the present invention is accordingly to be limited by nothing other than the appended claims, in which reference to an element in the singular means “at least one”. All structural and functional equivalents to the elements of the above-described preferred embodiment that are known or later come to be known to those of ordinary skill in the art are expressly incorporated herein by reference and are intended to be encompassed by the present claims. Moreover, it is not necessary for a device or method to address each and every problem sought to be solved by the present invention, for it to be encompassed by the present claims. Furthermore, no element, component, or method step in the present disclosure is intended to be dedicated to the public regardless of whether the element, component, or method step is explicitly recited in the claims. No claim element herein is to be construed under the provisions of 35 U.S.C. §112, sixth paragraph, unless the element is expressly recited using the phrase “means for”.

1. A system for presenting content on a TV, comprising:
at least one receiver TV presenting broadcast TV content;
at least one communication receiver;
at least one data cache receiving cache content via the receiver; and
at least one processor communicating with the data cache and presenting the cache content on the TV.

2. The system of claim 1, wherein the processor presents the cache content in response to a viewer-generated signal.

3. The system of claim 1, wherein the processor automatically presents the cache content in accordance with at least one cache content presentation rule.

4. The system of claim 1, further comprising a sender TV sending the cache content to the receiver TV peer-to-peer.

5. The system of claim 1, further comprising a server sending the cache content to the receiver TV server-to-client.

6. A system for presenting content on a TV, comprising:
at least one receiver TV presenting broadcast TV content;
at least one cache content receiver;
at least one data cache receiving cache content via the receiver; and
at least one processor communicating with the data cache and presenting the cache content on the TV.

7. The system of claim 6, wherein the cache content receiver is an AM radio receiver.

8. The system of claim 7, wherein the processor presents the cache content in response to a viewer-generated signal.

9. The system of claim 7, wherein the processor automatically presents the cache content in accordance with at least one cache content presentation rule.

10. The system of claim 6, further comprising a sender TV sending the cache content to the receiver TV peer-to-peer.

11. The system of claim 6, further comprising a server sending the cache content to the receiver TV server-to-client.

12. A method for presenting TV content and cache content on a TV simultaneously with each other, comprising:
receiving a TV signal and presenting it on a TV;
receiving cache content and storing the cache content in a data cache; and
in response to a cache content presentation rule or a viewer-generated signal, presenting cache content from the data cache on the TV along with the TV content.

13. The method of claim 12, comprising receiving the cache content via an AM radio receiver.

14. The method of claim 13, comprising receiving the cache content from a sender TV.

15. The method of claim 13, comprising receiving the cache content from a server.

16. A system for presenting out of band content on a TV, comprising:
receiver TV means for displaying television signals;
out of band content receiver means associated with the receiver TV means for receiving broadcast out of band content for presentation thereof on the TV, the out of band content not being a television signal.

17. The system of claim 16, wherein the out of band content is received from a sender TV.

18. The system of claim 16, wherein the out of band content is received from a server.

19. The system of claim 16, wherein the out of band content is cached at the receiver TV means.

20. The system of claim 16, wherein the out of band content receiver means is a radio.
